(19) United States
(12) Patent Application Publication
(10) Pub. No.: US 2025/0182744 A1
(43) Pub. Date: Jun. 5, 2025

(54) MODEL TRAINING FOR SPEECH PROCESSING

(71) Applicants: Bytedance Technology Ltd., Grand Cayman (KY); Beijing Youzhuju Network Technology Co., Ltd., Pinggu District (CN)

(72) Inventors: Yi Ren, Singapore (SG); Chen Zhang, Beijing (CN); Ziyue Jiang, Beijing (CN); Xiang Yin, Beijing (CN)

(21) Appl. No.: 19/048,517

(22) Filed: Feb. 7, 2025

(51) Int. Cl. G10L 15/06; G10L 15/02; G10L 15/187

(52) U.S. Cl. CPC G10L 15/063; G10L 15/02; G10L 15/187; G10L 2015/025

(57) ABSTRACT

Embodiments of the disclosure provide a solution for model training. A method includes: obtaining a training sample for training a machine learning model, the training sample comprising a sample speech, a sample text corresponding to the sample speech and speech duration information for the sample text, the machine learning model being configured to perform a plurality of tasks for speech processing; extracting a speech feature representation from the sample speech, a text feature representation from the sample text, a phoneme feature representation and a duration feature representation for the phoneme feature representation from the speech duration information; and training, according to the plurality of tasks, the machine learning model based on at least one of: the speech feature representation, the text feature representation or a combination of the phoneme feature representation and the duration feature representation.

### FIELD

The present disclosure generally relates to computer technologies, and more specifically, to a method, apparatus, device and computer readable storage medium for model training for speech processing.

### BACKGROUND

In recent years, neural codec language models and large-scale diffusion models have brought considerable advancements to the field of speech synthesis. Unlike traditional text-to-speech (TTS) systems, these models are trained on large-scale, multi-domain speech corpora, which contributes to notable improvements in the naturalness and expressiveness of synthesized audio. Given only seconds of speech prompt, these models can synthesize identity-preserving speech in a zero-shot manner.

### SUMMARY

In a first aspect of the present disclosure, there is provided a method for model training. The method comprises: obtaining a training sample for training a machine learning model, the training sample comprising a sample speech, a sample text corresponding to the sample speech and speech duration information for the sample text, the machine learning model being configured to perform a plurality of tasks for speech processing; extracting a speech feature representation from the sample speech, a text feature representation from the sample text, a phoneme feature representation and a duration feature representation for the phoneme feature representation from the speech duration information; and training, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

In a second aspect of the present disclosure, there is provided an apparatus for model training. The apparatus comprises: an obtaining module configured to obtain a training sample for training a machine learning model, the training sample comprising a sample speech, a sample text corresponding to the sample speech and speech duration information for the sample text, the machine learning model being configured to perform a plurality of tasks for speech processing; an extracting module configured to extract a speech feature representation from the sample speech, a text feature representation from the sample text, a phoneme feature representation and a duration feature representation for the phoneme feature representation from the speech duration information; and a training module configured to train, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

In a third aspect of the present disclosure, there is provided an electronic device. The electronic device comprises: at least one processor; and at least one memory coupled to the at least one processor and storing instructions executable by the at least one processor, the instructions, upon execution by the at least one processor, causing the electronic device to perform: obtaining a training sample for training a machine learning model, the training sample comprising a sample speech, a sample text corresponding to the sample speech and speech duration information for the sample text, the machine learning model being configured to perform a plurality of tasks for speech processing; extracting a speech feature representation from the sample speech, a text feature representation from the sample text, a phoneme feature representation and a duration feature representation for the phoneme feature representation from the speech duration information; and training, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

In a fourth aspect of the present disclosure, a computer-readable storage medium is provided. The computer-readable storage medium stores computer executable instructions which, when executed by an electronic device, causes the electronic device perform operations comprising: obtaining a training sample for training a machine learning model, the training sample comprising a sample speech, a sample text corresponding to the sample speech and speech duration information for the sample text, the machine learning model being configured to perform a plurality of tasks for speech processing; extracting a speech feature representation from the sample speech, a text feature representation from the sample text, a phoneme feature representation and a duration feature representation for the phoneme feature representation from the speech duration information; and training, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a schematic diagram of a relationship between the machine learning model and a TTS system in accordance with some embodiments of the present disclosure;

FIG. 3A illustrates a schematic diagram of an overall training process for the machine learning model in accordance with some embodiments of the present disclosure;

FIG. 3B illustrates a schematic diagram of a process of training the machine learning model for the first task of duration prediction in accordance with some embodiments of the present disclosure;

FIG. 3C illustrates a schematic diagram of a process of training the machine learning model for the second task of automatic speech recognition in accordance with some embodiments of the present disclosure;

FIG. 3D illustrates a schematic diagram of a process of training the machine learning model for the third task of G2P conversion or the fourth task of speech-text alignment in accordance with some embodiments of the present disclosure;

FIG. 4A illustrates a schematic diagram of performing the first task of duration prediction by the machine learning model 105 in accordance with some embodiments of the present disclosure;

FIG. 4B illustrates a schematic diagram of performing the second task of automatic speech recognition by the machine learning model 105 in accordance with some embodiments of the present disclosure;

FIG. 4C illustrates a schematic diagram of performing the third task of G2P conversion or the fourth task of speech-text alignment by the machine learning model in accordance with some embodiments of the present disclosure;

FIG. 5 illustrates a schematic diagram of an application environment of the machine learning model in accordance with some embodiments of the present disclosure;

FIG. 6 illustrates a flowchart of a process for model training in accordance with some embodiments of the present disclosure;

FIG. 7 shows a block diagram of an apparatus for model training in accordance with some embodiments of the present disclosure; and

FIG. 8 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

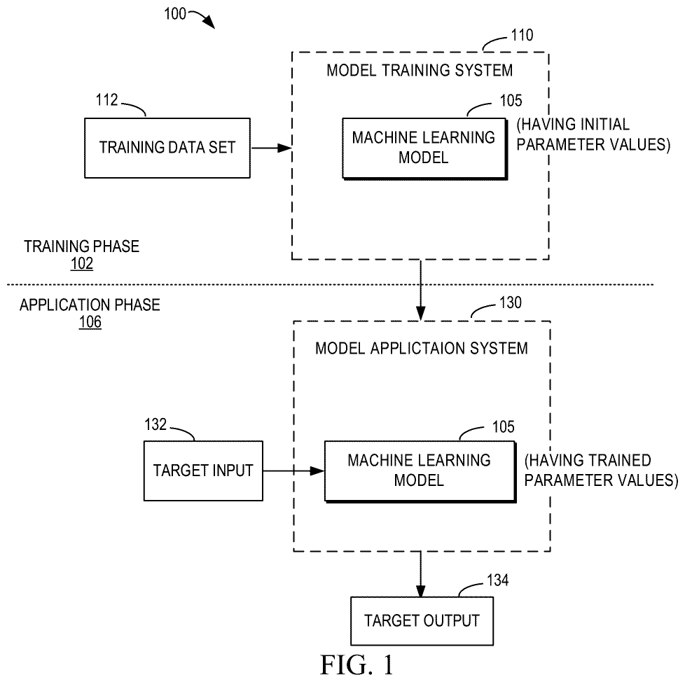

FIG. 1 illustrates a block diagram of an example environment 100 in which various embodiments of the present disclosure may be implemented. In the environment 100 of FIG. 1, two distinct phases of a model are showed, including a training phase 102 and an application phase 106. After the training phase 102 is completed, there may be a testing phase, which is not shown in FIG. 1.

In the training phase 102, a model training system 110 is configured to utilize a training dataset 112 to perform training of the machine learning model 105. At the beginning of training, the machine learning model 105 may have initial parameter values. The training process is to update the parameter values of the machine learning model 105 to the expected values based on the training data. In some embodiments, the machine learning model 105 is configured to generate a speech.

In the application phase 106, the machine learning model 105 having trained parameter values may be provided to a model application system 130 for use. In the application phase 106, the machine learning model 105 may be used to process a target input 132 and provide a corresponding target output 134.

In FIG. 1, the model training system 110 and the model application system 130 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure. In an example, although shown as separate, the model training system 110 and the model application system 130 may be integrated into a same system or device. The implementation method disclosed herein is not limited in this regard.

As briefly mentioned above, the TTS system may generate a speech given a text. In previous zero-shot TTS pipelines, training and inference often rely on various frontend systems. In traditional TTS systems, the frontend typically refers to text analysis modules, such as text normalization and grapheme-to-phoneme (G2P) conversion. With the emergence of zero-shot TTS, the frontend has taken on additional responsibilities, including processing the prompt speech during the inference stage, which should at least support automatic speech recognition (ASR). Moreover, some advanced non-autoregressive models require additional speech-text aligners and duration predictors. These complex frontend systems impose significant limitations on the efficiency of zero-shot TTS models.

Embodiments of the present disclosure propose an improved solution for model training. In this solution, a training sample for training a machine learning model. The training sample comprises a sample speech, a sample text corresponding to the sample speech and speech duration information for the sample text. The machine learning model is configured to perform a plurality of tasks for speech processing. A speech feature representation is extracted from the sample speech, a text feature representation is extracted from the sample text, a phoneme feature representation and a duration feature representation for the phoneme feature representation are extracted from the speech duration information. The machine learning model is trained, according to the plurality of tasks, based on at least one of: the speech feature representation, the text feature representation or a combination of the phoneme feature representation and the duration feature representation. The plurality of tasks comprises a first task of duration prediction, a second task of automatic speech recognition (ASR), a third task of grapheme-to-phoneme (G2P) conversion and a fourth task of speech-text alignment.

With these embodiments of the present disclosure, a unified machine learning model may be trained according to different tasks related to speech processing. In this way, the unified machine learning model may cover various speech processing tasks required by a TTS system in a single autoregressive process and thus the efficiency of facilitating the TTS system may be improved.

Example embodiments of the present disclosure will be described with reference to the drawings.

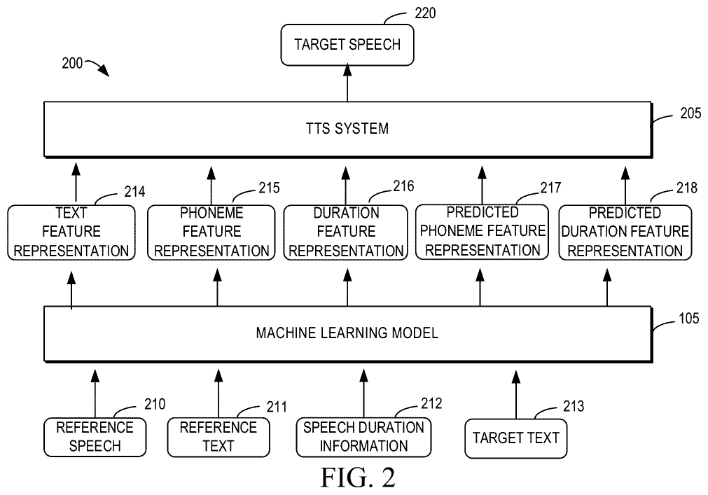

FIG. 2 illustrates a schematic diagram 200 of a relationship between the machine learning model 105 and a TTS system 205 in accordance with some embodiments of the present disclosure. As shown in FIG. 2, the machine learning model 105 (which may be included in a frontend system for the TTS system 205) may perform a plurality of tasks related to speech processing required by the TTS system 205. In some examples, the plurality of tasks may include a first task of duration prediction, a second task of automatic speech recognition (ASR), a third task of grapheme-to-phoneme (G2P) conversion and a fourth task of speech-text alignment.

In some embodiments, the machine learning model 105 may be constructed based on a language model. The machine learning model 105 constructed based on the language model may sometimes be called as a frontend language model. In some examples, the machine learning model 105 may be constructed based on other content generation models. In some examples, the TTS system 205 may be constructed based on a diffusion model which is configured to generate a speech corresponding to a text based on input feature representations.

In some embodiments, to perform the first task of duration prediction, the machine learning model 105 may generate a predicted phoneme feature representation 217 and a predicted duration feature representation 218 corresponding to a target text 213 based on a reference speech 210, a reference text 211 corresponding to the reference speech 210, speech duration information 213 for the reference text 211 and the target text 213. A phoneme feature representation characterizes a phoneme in the text and indicates an acoustic duration for the corresponding phoneme, which may sometimes be represented as the number of audio frames. In some examples, the TTS system 205 may generate the target speech 220 corresponding to the target text 213 where each phoneme corresponds to a duration as specified in a combination of the predicted phoneme feature representation 217 and the predicted duration feature representation 218.

In some embodiments, to perform the second task of ASR, the machine learning model 105 may generate a text feature representation 214 based on the reference speech 210. The machine learning model 105 may take a text corresponding to the reference speech 210 as input and convert it into the text feature representation 214 (e.g., a numerical representation) that captures the semantic meaning and structure of the text. In some examples, the TTS system 205 may take the text feature representation 214 as input and generate a target speech 220 with a timbre or a prosody different from the timbre or prosody in the reference speech 210.

In some embodiments, to perform the third task of G2P conversion, the machine learning model 105 may generate a phoneme feature representation 215 based on the reference speech 210 and the reference text 211 corresponding to the reference speech 210. Phonemes are the basic building blocks of a speech, from which continuous speech streams are constructed. In some examples, the TTS system 205 may take the phoneme feature representation 215 as input and generate the target speech 220 with phonemes included in the phoneme feature representation 215.

In some embodiments, to perform the fourth task of speech-text alignment, the machine learning model 105 may generate the phoneme feature representation 215 and a duration feature representation 216 for the phoneme feature representation 215 based on the reference text 211 and speech duration information 212 for the reference text 211. A combination of the phoneme feature representation 215 and the duration feature representation 216 may indicate a duration of each phoneme in the phoneme feature representation 215. In some examples, the TTS system 205 may generate the target speech 220 where each phoneme corresponds to a duration as specified in the combination of the phoneme feature representation 215 and the duration feature representation 216.

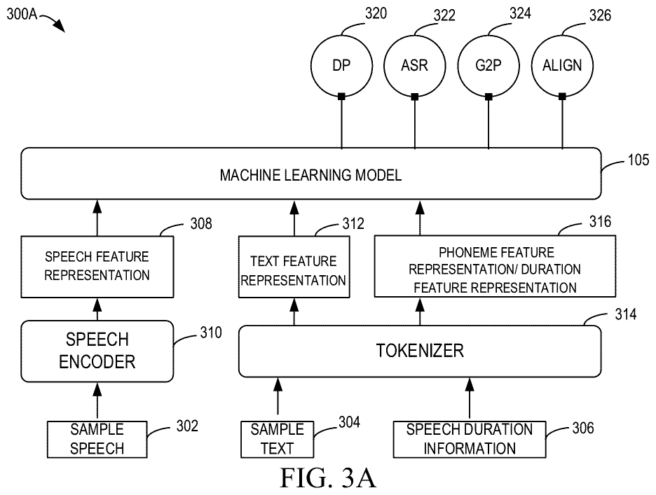

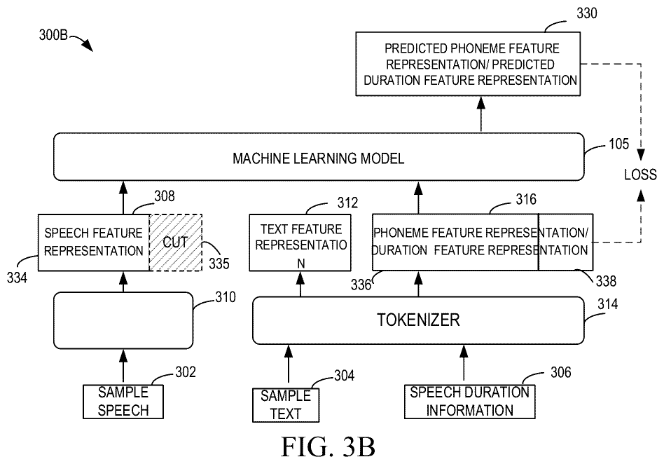

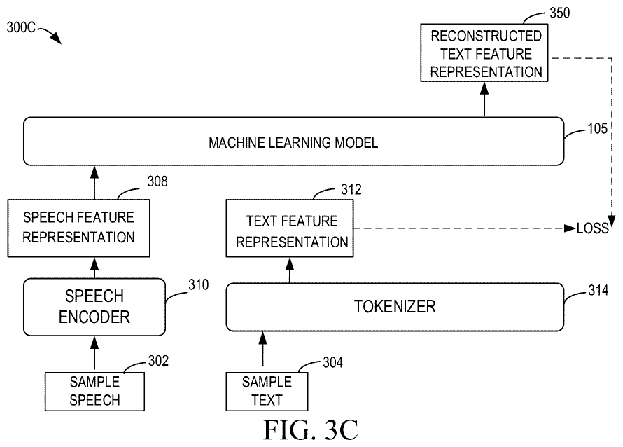

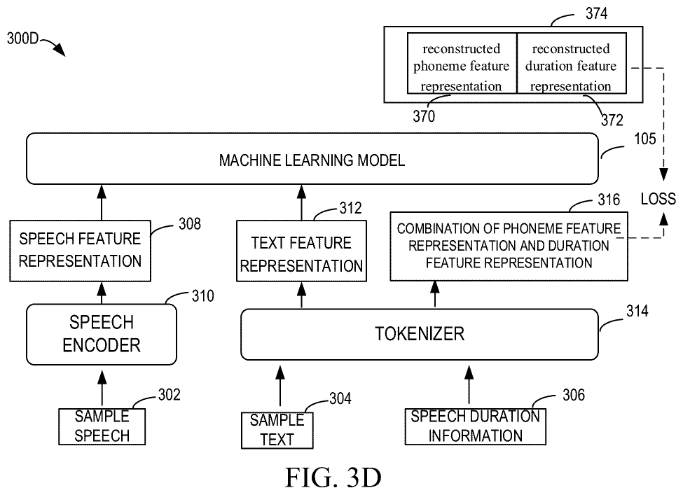

To allow the machine learning model 105 to support any of the four tasks as mentioned above, a training strategy of the machine learning model 105 may be designed based on the four tasks. Detailed training process for the machine learning model 105 may be described with reference to FIGS. 3A-3D.

FIG. 3A illustrates a schematic diagram 300A of an overall training process for the machine learning model 105 in accordance with some embodiments of the present disclosure. As shown in FIG. 3A, a training sample for training a machine learning model 105 is obtained. The training sample includes a sample speech 302, a sample text 304 corresponding to the sample speech 302 and speech duration information 306 for the sample text 304. The machine learning model 105 is configured to perform a plurality of tasks for speech processing. In some examples, the TTS system 205 may generate a speech based on information output by the machine learning model 105.

After obtaining the training sample, a speech feature representation 308 (also referred to as speech vector sequence) may be extracted from the sample speech 302 using a speech encoder 310. A text feature representation 312 may be extracted from the sample text 304 using a tokenizer 314. A phoneme feature representation (also referred to as phoneme embedding sequence) and a duration feature representation (also referred to as duration embedding sequence) for the phoneme feature representation may be extracted from the speech duration information 306 using the tokenizer 314.

In the example of FIG. 3A, the speech encoder 310 may take the sample speech 302 as input and generate the speech feature representation 308 which may characterize important linguistic and acoustic information included in the sample speech 302. The speech encoder 310 may be configured as any suitable type of models that is capable of extracting features form a speech. In some examples, the speech encoder 310 is constructed based on a transformer, convolutional neural networks (CNN), recurrent neural network (RNN) and the like.

The tokenizer 314 may take the sample text 304 as input and generate the text feature representation 312 which captures the semantic meaning and structure of the sample text 304. Furthermore, the tokenizer 314 may take the speech duration information 306 as input and generate the phoneme feature representation and the duration feature representation. In some examples, the phoneme feature representation characterizes a phoneme in the sample text 304. The phoneme feature representation indicates an acoustic duration for a corresponding phoneme, which may sometimes be represented as the number of audio frames.

In some examples, the speech feature representation 308 may be denoted as a=[a₁, a₂, . . . , aₘ], the text feature representation 312 may be denoted as t=[t₁, t₂, . . . , t_{\hat{m}}], the phoneme feature representation may be denoted as p=[p₁, p₂, . . . , pₘ] and the duration feature representation may be denoted as d=[d₁, d₂, . . . , dₘ].

In some embodiments, the text feature representation 312 may comprise byte-pair encoding (BPE) sequence of the sample text. With these embodiments, BPE effectively reduces the size of the vocabulary required to represent text, which can significantly enhance computational efficiency during training and inference the machine learning model 105. In this way, a robust and efficient way to handle text data in speech processing is provided.

In some embodiments, for the duration feature representation, to inform the machine learning model 105 of how long it has been speaking during inference, the absolute timestamp of each phoneme on the time axis may be used to construct a combination 316 of the phoneme feature representation and the duration feature representation (also referred to as “phoneme/timestamp tokens” sequence). The combination 316 of the phoneme feature representation and the duration feature representation may be denoted as \hat{p}ₜ=[p₁, d₁, p₂, d₁+d₂, . . . , pₘ, ∈ᵢ₌₁^{m} dᵢ], where Σᵢ₌₁^{m} dᵢ indicates the absolute timestamp of each phoneme is employed to indicate the duration for each phoneme. Furthermore, the absolute timestamp of each phoneme refers to the timestamp at the end of each phoneme.

After the above feature representations are extracted, the machine learning model 105 may be trained according to the plurality of tasks based on at least one of: the speech feature representation 308, the text feature representation 312 or the combination 316 of the phoneme feature representation and the duration feature representation. The plurality of tasks may include a first task 320 of duration prediction, a second task 322 of ASR, a third task 324 of G2P conversion and a fourth task 326 of speech-text alignment. The required input for each of the tasks may be different, as described above.

In some embodiments, the speech feature representation 308, the text feature representation 312 and the combination 316 of the phoneme feature representation and the duration feature representation may be concatenated as an input (denoted as h) to the decoder-only machine learning model 105. The input may be represented as h=[a₁, . . . , aₗ, t₁, . . . , t_{\hat{m}}, p₁, d₁, . . . , pₘ, Σᵢ₌₁^{m} dᵢ]. In some examples, special tokens may be added in h to indicate the start and end of the sequence t and the start and end of the sequence \hat{p}ₜ.

In some embodiments, different information contained in the input may be used to train the machine learning model 105 for different tasks.

FIG. 3B illustrates a schematic diagram 300B of a process of training the machine learning model 105 for the first task in accordance with some embodiments of the present disclosure. As shown in FIG. 3B, a part of the speech feature representation 308 may be masked. A combination 330 of a predicted phoneme feature representation and a predicted duration feature representation may be generated based on an unmasked part 334 of the speech feature representation 308, the text feature representation 312 and a first part 336 of the combination 316 of the phoneme feature representation and the duration feature representation corresponding to the unmasked part 334 of the speech feature representation 308 using the machine learning model 105. In some examples, the latter part of the speech feature representation 308 may be randomly discarded.

After the combination 330 of the predicted phoneme feature representation and the predicted duration feature representation is generated, the machine learning model 105 may be trained, according to the first task, based on a difference between the combination 330 of the predicted phoneme feature representation and the predicted duration feature representation and a second part 338 of the combination 316 of the phoneme feature representation and the duration feature representation corresponding to the masked part 335 of the speech feature representation 308. The second part 338 of the combination 316 may be regarded as the ground truth for the combination 330. In some examples, the machine learning model 105 may be trained based on a training objective, which is configured to reduce or minimize the difference between the combination 330 and the second part 338 of the combination 316. With these embodiments, the machine learning model is trained according to the task of duration prediction. In this way, the machine learning model may predict durations of respective phonemes in an unseen text. Furthermore, the TTS system 205 may generate the target speech 220 in which each phoneme corresponds to a duration specified in the durations of respective phonemes output by the machine learning model 105.

FIG. 3C illustrates a schematic diagram 300C of a process of training the machine learning model 105 for the second task in accordance with some embodiments of the present disclosure. As shown in FIG. 3C, a reconstructed text feature representation 350 may be generated based on the speech feature representation 308 using the machine learning model 105. Then, the machine learning model 105 may be trained, according to the second task, based on a difference between the reconstructed text feature representation 350 and the text feature representation 312. The text feature representation 312 may be regarded as the ground truth for the reconstructed text feature representation 350. In some examples, the machine learning model 105 may be trained based on a training objective, which is configured to reduce or minimize the difference between the reconstructed text feature representation 350 and the text feature representation 312. With these embodiments, the machine learning model 105 is trained according to the task of ASR. In this way, the machine learning model 105 may convert works spoken in a speech into a text. Furthermore, the TTS system 205 may generate the target speech 220 corresponding to the text output by the machine learning model 105.

FIG. 3D illustrates a schematic diagram 300D of a process of training the machine learning model 105 for the third task or the fourth task in accordance with some embodiments of the present disclosure. As shown in FIG. 3D, a reconstructed phoneme feature representation 370 and a reconstructed duration feature representation 372 may be generated based on the speech feature representation 308 and the text feature representation 312 using the machine learning model 105. The machine learning model 105 may be trained, according to the third task, based on a difference between the reconstructed phoneme feature representation 370 and the phoneme feature representation contained in the combination 316. The phoneme feature representation may be regarded as the ground truth for the reconstructed phoneme feature representation 370. In some examples, the machine learning model 105 may be trained based on a training objective, which is configured to reduce or minimize the difference between the reconstructed phoneme feature representation 370 and the phoneme feature representation. With these embodiments, the machine learning model 105 is trained according to the task of G2P conversion. In this way, the machine learning model 105 may transform written words (graphemes) into their corresponding phonetic representations (phonemes) and thus the TTS system 205 may accurately pronounce written text by converting it into a sequence of phonemes that can be synthesized into speech.

Alternatively, or in addition, the machine learning model 105 may be trained, according to the fourth task, based on a difference between a combination 374 of the reconstructed phoneme feature representation 370 and the reconstructed duration feature representation 372 and the combination 316 of the phoneme feature representation and the duration feature representation. The combination 316 may be regarded as the ground truth for the combination 374. In some examples, the machine learning model 105 may be trained based on a training objective, which is configured to reduce or minimize the difference between the combination 374 and the combination 316. With these embodiments, the machine learning model 105 is trained according to the task of speech-text alignment. In this way, the machine learning model 105 may establish an alignment mapping from text to speech signals and thus fine-grained control over durations of each phoneme may be enabled.

With these embodiments, the unified training related to the sour tasks may improve the robustness and generalization of the machine learning model 105.

In some embodiments, the machine learning model 105 may be fine-tuned based on training data from a plurality of domains. In some examples, the training data may include data from movies, data from audio books, data from audio-sharing applications. In this way, the machine learning model 105 may be experts in these domains.

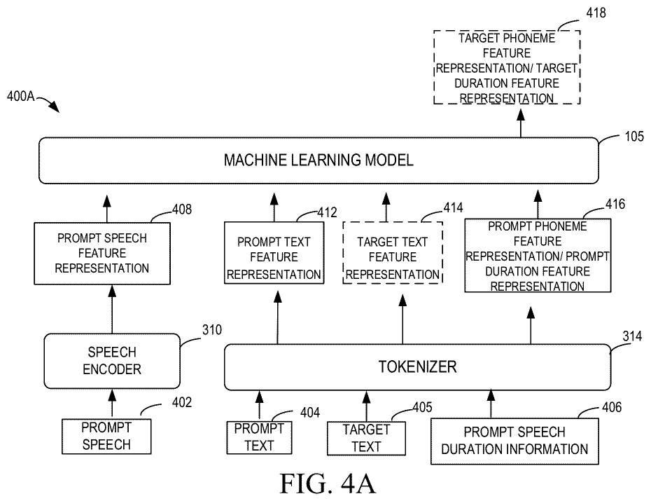

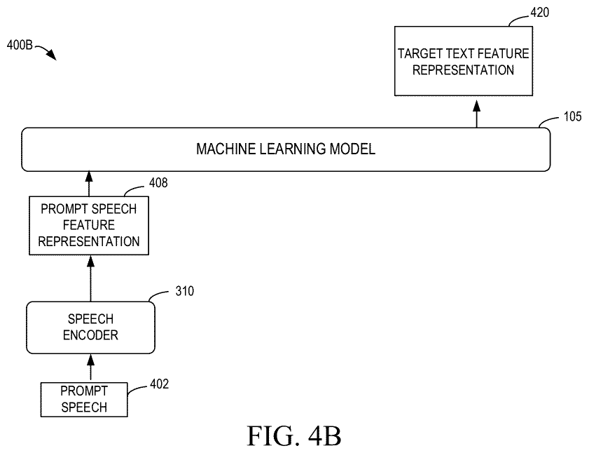

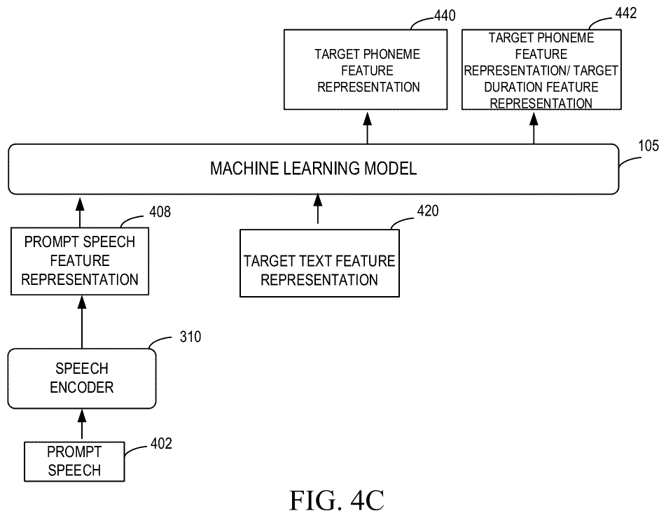

After the training according to the four types of tasks, the machine learning model 105 may be capable of performing any of the first to the fourth tasks. Detailed inference process of the machine learning model 105 may be described with reference to FIGS. 4A-4C.

FIG. 4A illustrates a schematic diagram 400A of performing the first task of duration prediction by the machine learning model 105 in accordance with some embodiments of the present disclosure. As shown in FIG. 4A, prompt information is given and the prompt information may include a prompt speech 402, a prompt text 404 corresponding to the prompt speech 402 and prompt speech duration information 406 for the prompt text 404. A prompt speech feature 408 may be extracted from the prompt speech 402 using a speech encoder 310. A prompt text feature representation 412 may be extracted from the prompt text 404 using a tokenizer 314. A combination 416 of a prompt phoneme feature representation and a prompt duration feature representation may be extracted from the prompt speech duration information 406 using the tokenizer 314. Then, a combination 418 of target phoneme feature representation and target duration feature representation for a target speech may be determined based on the prompt speech feature representation 408, the prompt text feature representation 412, target text feature representation 414 extracted from a target text 405 corresponding to the target speech and the combination 416 of prompt phoneme feature representation and prompt duration feature representation.

FIG. 4B illustrates a schematic diagram 400B of performing the second task of ASR by the machine learning model 105 in accordance with some embodiments of the present disclosure. As shown in FIG. 4B, a prompt speech feature representation 408 may be extracted from a prompt speech 402 by the speech encoder 408. A target text feature representation 420 may be determined based on the prompt speech feature representation 408 using the trained machine learning model 105.

FIG. 4C illustrates a schematic diagram 400C of performing the third task of G2P conversion or the fourth task of speech-text alignment by the machine learning model 105 in accordance with some embodiments of the present disclosure. As shown in FIG. 4C, a target phoneme feature representation 440 or a combination 442 of the target phoneme feature representation 440 and a target duration feature representation may be determined using the trained machine learning model 105 based on the prompt speech feature representation 408 and the target text feature representation 420. With these embodiments, the entire inference pipeline can be completed in a single autoregressive process, making the machine learning model 105 highly efficient. In addition, the machine learning model 105 achieves superior and generalizable performance than that of individual frontend systems.

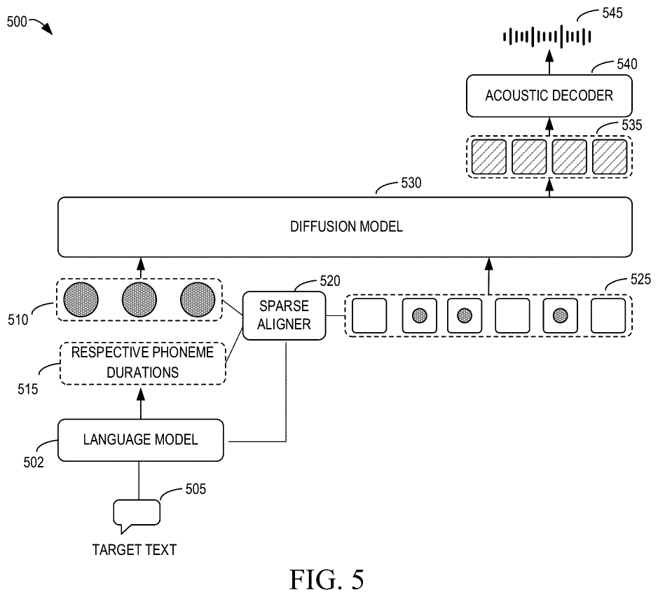

The following will describe an example of the machine learning model 105 and the TTS system 205 collaborating to perform speech generation with reference to FIG. 5, which illustrates a schematic diagram 500 of an application environment of the machine learning model 105 in accordance with some embodiments of the present disclosure. As shown in FIG. 5, a language model 502 (as an example of the machine learning model 105) perform the task of duration prediction. Specifically, the language model may take a target text 505 as input and generate a plurality of phoneme feature representations 510 (as an example of the target phoneme feature representation) corresponding to a sequence of phonemes in the target text 505 and respective phoneme durations 515 (as an example of the target duration feature representation) for the plurality of phoneme feature representations. The generation of the plurality of phoneme feature representations 510 and the respective phoneme durations 515 is related to the task of duration prediction.

A sparse aligner 520 may adjust the length of each phoneme in the plurality of phoneme feature representations 510 based on a duration corresponding to the phoneme. As a result, the sparse aligner 520 may generate a sequence of adjusted phoneme feature representations 525.

In some examples, for a phoneme feature representation in the plurality of phoneme feature representations 510, the sparse aligner 520 may repeat the phoneme feature representation based on the number of repetitions indicated by a phoneme duration corresponding to the phoneme feature representation. Respective repeated phoneme feature representations for the plurality of phoneme feature representations 510 may be concatenated in an order of the plurality of phoneme feature representations 510, to obtain an extended sequence of phoneme feature representations. In an example, the plurality of phoneme feature representations 510 are denoted as p and the respective phoneme durations 515 are denoted as d. Given p=[p₁, p₂, p₃] and d=[2,2,3], p₁ and p₂ may be repeated twice, and p₃ may be repeated three times. Then, respective repeated phoneme feature representations for p₁, p₂, p₃ may be concatenated in the order of p₁, p₂, p₃, to obtain the extended sequence of phoneme feature representations, which may be denoted as a=[p₁,p₁,p₂,p₂,p₃,p₃,p₃].

After the extended sequence of phoneme feature representations is obtained, for a phoneme feature representation in the plurality of phoneme feature representations 510, the sparse aligner 520 may mask one or more of repeated phoneme feature representations for the phoneme feature representation in the extended sequence of phoneme feature representations, to retain one of the repeated phoneme feature representations for the phoneme feature representation. That is, among the repeated phoneme feature representations for one phoneme, one phoneme feature representation is retained and the remaining one(s) may be masked.

For example, the plurality of phoneme feature representations 510 may include p₁,p₂ p₃ and extended sequence of phoneme feature representations may be denoted as a=[p₁,p₁,p₂,p₂,p₃,p₃,p₃]. As a result, one or more of repeated phoneme feature representations (i.e., p₁,p₁,p₂,p₂ and p₃,p₃,p₃) for the phoneme feature representation in the extended sequence of phoneme feature representations may be masked by the sparse aligner 520, to retain one of the repeated phoneme feature representations for the phoneme feature representation. In other words, only one anchor for each phoneme feature representation (i.e., p₁, p₂ and p₃) in the extended sequence of phoneme feature representations may be retained. For example, the sequence of adjusted phoneme feature representations 525 may be represented as ã=[M, p₁,p₂, M,M,M,p₃], where M represents a masked token (also referred to as a masked vector), p₁, p₂ and p₃ represents the anchor for each phoneme feature representation.

Then, a diffusion model 530 (as a part of the TTS system 205) may take the sequence of adjusted phoneme feature representations 525 as input and generate a target speech feature representation 535. An acoustic decoder 540 (as another part of the TTS system 205) may take the target speech feature representation 535 as input and generate a corresponding speech 545 in which each phoneme corresponds to a duration specified in the sequence of adjusted phoneme feature representations 525. In some embodiments, the acoustic decoder 540 may include a wave decoder, which is configured to process the input speech latent vector (e.g., the target speech feature representation 535) corresponding to a speech and generate an acoustic wave corresponding to the speech (e.g., speech 545).

In some embodiments, the language model 502 may take a target speech (not shown) as input and generate a text feature representation. The generation of the target text feature representation is related to the task of ASR. Then, the diffusion model 530 may take the text feature representation as input and generate a speech feature representation. The acoustic decoder 540 may decode the speech feature representation into a speech, which may have a timbre, prosodic patten or accent different from that in the target speech.

In some embodiments, the language model 502 may take the target text 505 and the target speech as input and generate a phoneme feature representation. The generation of the phoneme feature representation is related to the task of G2P conversion. Then, the diffusion model 530 may take the phoneme feature representation as input and generate a speech feature representation. The acoustic decoder 540 may decode the speech feature representation into a speech, which may have phonemes represented in the phoneme feature representation.

In some embodiments, the language model 502 may take the target text 505 and speech duration information (not shown) for the target text 505 and generate a phoneme feature representation and a duration feature representation for the phoneme feature representation. The generation of the phoneme feature representation and the duration feature representation relates to the task of speech-text alignment. Then, the diffusion model 530 may take the phoneme feature representation and the duration feature representation as input and generate a speech feature representation. The acoustic decoder 540 may decode the speech feature representation into a speech where each phoneme corresponds to a duration as specified in the combination of the phoneme feature representation and the duration feature representation.

With the help of the language model 502, the efficiency of generating a high-quality speech by the diffusion model 530 and the acoustic decoder 540 may be improved.

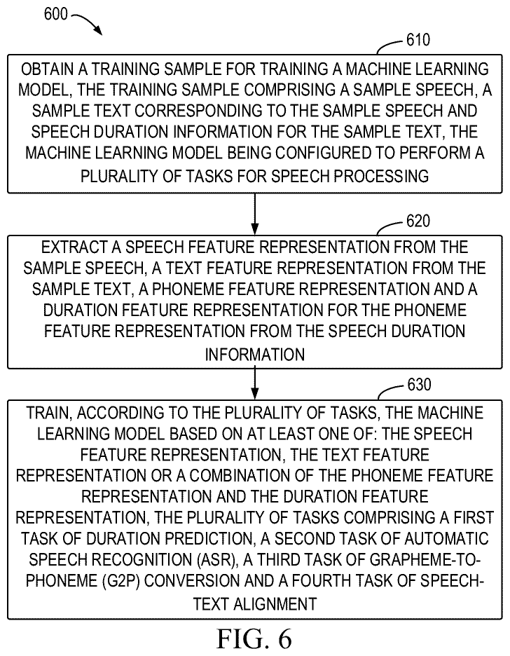

FIG. 6 illustrates a flowchart of a process 600 for model training in accordance with some embodiments of the present disclosure. The process 600 may be implemented at the model training system 110 or the model application system 130 of FIG. 1.

At block 610, the model training system 110 obtains a training sample for training a machine learning model, the training sample comprising a sample speech, a sample text corresponding to the sample speech and speech duration information for the sample text, the machine learning model being configured to perform a plurality of tasks for speech processing.

At block 620, the model training system 110 extracts a speech feature representation from the sample speech, a text feature representation from the sample text, a phoneme feature representation and a duration feature representation for the phoneme feature representation from the speech duration information.

At block 630, the model training system 110 trains, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

In some embodiments, a part of the speech feature representation is masked, and wherein training the machine learning model comprises: generating, using the machine learning model, a combination of a predicted phoneme feature representation and a predicted duration feature representation based on an unmasked part of the speech feature representation, the text feature representation and a first part of the combination of the phoneme feature representation and the duration feature representation corresponding to the unmasked part of the speech feature representation; and training, according to the first task, the machine learning model based on a difference between the combination of the predicted phoneme feature representation and the predicted duration feature representation and a second part of the combination of the phoneme feature representation and the duration feature representation corresponding to the masked part of the speech feature representation.

In some embodiments, training the machine learning model comprises: generating, using the machine learning model, a reconstructed text feature representation based on the speech feature representation; and training, according to the second task, the machine learning model based on a difference between the reconstructed text feature representation and the text feature representation.

In some embodiments, training the machine learning model comprises: generating, using the machine learning model, a reconstructed phoneme feature representation and a reconstructed duration feature representation based on the speech feature representation and the text feature representation; and training, according to the third task, the machine learning model based on a difference between the reconstructed phoneme feature representation and the phoneme feature representation; or training, according to the fourth task, the machine learning model based on a difference between a combination of the reconstructed phoneme feature representation and the reconstructed duration feature representation and the combination of the phoneme feature representation and the duration feature representation.

In some embodiments, the process 600 further comprises extracting a prompt speech feature representation from a prompt speech, a prompt text feature representation from a prompt text corresponding to the prompt speech, and a combination of a prompt phoneme feature representation and a prompt duration feature representation from prompt speech duration information for the prompt text; and determining, using the trained machine learning model, a combination of target phoneme feature representation and target duration feature representation for a target speech based on the prompt speech feature representation, the prompt text feature representation, target text feature representation extracted from a target text corresponding to the target speech and the combination of prompt phoneme feature representation and prompt duration feature representation.

In some embodiments, the process 600 further comprises extracting a prompt speech feature representation from a prompt speech; and determining, using the trained machine learning model, a target text feature representation based on the prompt speech feature representation.

In some embodiments, the process 600 further comprises determining, using the trained machine learning model, a target phoneme feature representation or a combination of the target phoneme feature representation and a target duration feature representation based on the prompt speech feature representation and the target text feature representation.

In some embodiments, the text feature representation comprises byte-pair encoding (BPE) sequence of the sample text.

In some embodiments, the machine learning model is constructed based on a language model.

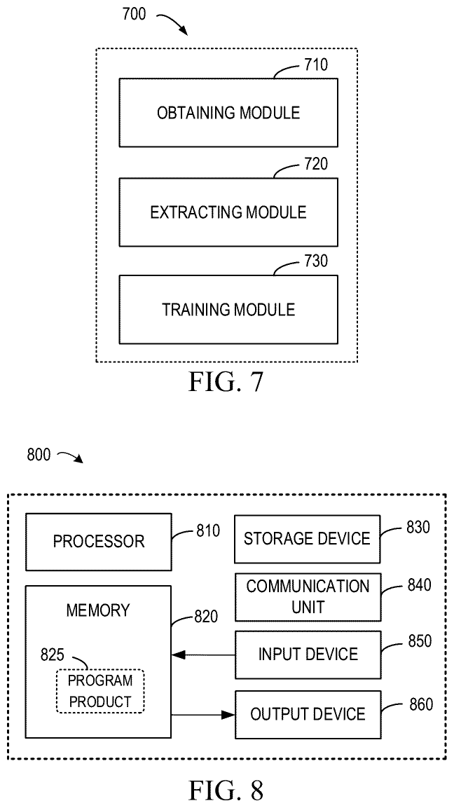

FIG. 7 shows a block diagram of an apparatus 700 for model training in accordance with some embodiments of the present disclosure. The apparatus 700 may be implemented, for example, or included at the model training system 110 or the model application system 130 of FIG. 1. Various modules/components in the apparatus 700 may be implemented by hardware, software, firmware, or any combination thereof.

As shown, the apparatus 700 includes an obtaining module 710 configured to obtain a training sample for training a machine learning model, the training sample comprising a sample speech, a sample text corresponding to the sample speech and speech duration information for the sample text, the machine learning model being configured to perform a plurality of tasks for speech processing.

The apparatus 700 includes an extracting module 720 configured to extract a speech feature representation from the sample speech, a text feature representation from the sample text, a phoneme feature representation and a duration feature representation for the phoneme feature representation from the speech duration information.

The apparatus 700 further includes a training module 730 configured to train, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

In some embodiments, a part of the speech feature representation is masked. The training module 630 is further configured to generate, using the machine learning model, a combination of a predicted phoneme feature representation and a predicted duration feature representation based on an unmasked part of the speech feature representation, the text feature representation and a first part of the combination of the phoneme feature representation and the duration feature representation corresponding to the unmasked part of the speech feature representation; and train, according to the first task, the machine learning model based on a difference between the combination of the predicted phoneme feature representation and the predicted duration feature representation and a second part of the combination of the phoneme feature representation and the duration feature representation corresponding to the masked part of the speech feature representation.

In some embodiments, the training module 730 is further configured to generate, using the machine learning model, a reconstructed text feature representation based on the speech feature representation; and train, according to the second task, the machine learning model based on a difference between the reconstructed text feature representation and the text feature representation.

In some embodiments, the training module 730 is further configured to generate, using the machine learning model, a reconstructed phoneme feature representation and a reconstructed duration feature representation based on the speech feature representation and the text feature representation; and train, according to the third task, the machine learning model based on a difference between the reconstructed phoneme feature representation and the phoneme feature representation; or train, according to the fourth task, the machine learning model based on a difference between a combination of the reconstructed phoneme feature representation and the reconstructed duration feature representation and the combination of the phoneme feature representation and the duration feature representation.

In some embodiments, the apparatus 700 further includes a first performing module configured to extract a prompt speech feature representation from a prompt speech, a prompt text feature representation from a prompt text corresponding to the prompt speech, and a combination of a prompt phoneme feature representation and a prompt duration feature representation from prompt speech duration information for the prompt text; and determine, using the trained machine learning model, a combination of target phoneme feature representation and target duration feature representation for a target speech based on the prompt speech feature representation, the prompt text feature representation, target text feature representation extracted from a target text corresponding to the target speech and the combination of prompt phoneme feature representation and prompt duration feature representation.

In some embodiments, the apparatus 700 further includes a second performing module configured to extract a prompt speech feature representation from a prompt speech; and determine, using the trained machine learning model, a target text feature representation based on the prompt speech feature representation.

In some embodiments, the apparatus 700 further includes a third performing module configured to determine, using the trained machine learning model, a target phoneme feature representation or a combination of the target phoneme feature representation and a target duration feature representation based on the prompt speech feature representation and the target text feature representation.

In some embodiments, the text feature representation comprises byte-pair encoding (BPE) sequence of the sample text.

In some embodiments, the machine learning model is constructed based on a language model.

FIG. 8 illustrates a block diagram of an electronic device 800 in which one or more embodiments of the present disclosure can be implemented. It would be appreciated that the electronic device 800 shown in FIG. 8 is only an example and should not constitute any restriction on the function and scope of the embodiments described herein. The electronic device 800 may be used, for example, to implement the model training system 110 or the model application system of FIG. 1. The electronic device 800 may also be used to implement the apparatus 700 of FIG. 7.

As shown in FIG. 8, the electronic device 800 is in the form of a general computing device. The components of the electronic device 800 may include, but are not limited to, one or more processing units or processors 810, a memory 820, a storage device 830, one or more communication units 840, one or more input devices 850, and one or more output devices 860. The processor 810 may be an actual or virtual processor and can execute various processes according to the programs stored in the memory 820. In a multiprocessor system, multiple processing units execute computer executable instructions in parallel to improve the parallel processing capability of the electronic device 800.

The electronic device 800 typically includes a variety of computer storage medium. Such medium may be any available medium that is accessible to the electronic device 800, including but not limited to volatile and non-volatile medium, removable and non-removable medium. The memory 820 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 830 may be any removable or non-removable medium, and may include a machine-readable medium, such as a flash drive, a disk, or any other medium, which can be used to store information and/or data (such as training data for training) and can be accessed within the electronic device 800.

The electronic device 800 may further include additional removable/non-removable, volatile/non-volatile, transitory/non-transitory storage medium. Although not shown in FIG. 8, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 820 may include a computer program product 825, which has one or more program modules configured to perform various methods or acts of various embodiments of the present disclosure.

The communication unit 840 communicates with a further computing device through the communication medium. In addition, functions of components in the electronic device 800 may be implemented by a single computing cluster or multiple computing machines, which can communicate through a communication connection. Therefore, the electronic device 800 may be operated in a networking environment using a logical connection with one or more other servers, a network personal computer (PC), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required. The external device, such as a storage device, a display device, etc., communicate with one or more devices that enable users to interact with the electronic device 800, or communicate with any device (for example, a network card, a modem, etc.) that makes the electronic device 800 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for model training, comprising:
obtaining a training sample for training a machine learning model, the training sample comprising a sample speech, a sample text corresponding to the sample speech and speech duration information for the sample text, the machine learning model being configured to perform a plurality of tasks for speech processing;
extracting a speech feature representation from the sample speech, a text feature representation from the sample text, a phoneme feature representation and a duration feature representation for the phoneme feature representation from the speech duration information; and
training, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

2. The method of claim 1, wherein a part of the speech feature representation is masked, and wherein training the machine learning model comprises:
generating, using the machine learning model, a combination of a predicted phoneme feature representation and a predicted duration feature representation based on an unmasked part of the speech feature representation, the text feature representation and a first part of the combination of the phoneme feature representation and the duration feature representation corresponding to the unmasked part of the speech feature representation; and
training, according to the first task, the machine learning model based on a difference between the combination of the predicted phoneme feature representation and the predicted duration feature representation and a second part of the combination of the phoneme feature representation and the duration feature representation corresponding to the masked part of the speech feature representation.

3. The method of claim 1, wherein training the machine learning model comprises:
generating, using the machine learning model, a reconstructed text feature representation based on the speech feature representation; and
training, according to the second task, the machine learning model based on a difference between the reconstructed text feature representation and the text feature representation.

4. The method of claim 1, wherein training the machine learning model comprises:
generating, using the machine learning model, a reconstructed phoneme feature representation and a reconstructed duration feature representation based on the speech feature representation and the text feature representation; and
training, according to the third task, the machine learning model based on a difference between the reconstructed phoneme feature representation and the phoneme feature representation; or
training, according to the fourth task, the machine learning model based on a difference between a combination of the reconstructed phoneme feature representation and the reconstructed duration feature representation and the combination of the phoneme feature representation and the duration feature representation.

5. The method of claim 1, further comprising:
extracting a prompt speech feature representation from a prompt speech, a prompt text feature representation from a prompt text corresponding to the prompt speech, and a combination of a prompt phoneme feature representation and a prompt duration feature representation from prompt speech duration information for the prompt text; and
determining, using the trained machine learning model, a combination of a target phoneme feature representation and a target duration feature representation for a target speech based on the prompt speech feature representation, the prompt text feature representation, target text feature representation extracted from a target text corresponding to the target speech and the combination of prompt phoneme feature representation and prompt duration feature representation.

6. The method of claim 1, further comprising:
extracting a prompt speech feature representation from a prompt speech; and
determining, using the trained machine learning model, a target text feature representation based on the prompt speech feature representation.

7. The method of claim 6, further comprising:
determining, using the trained machine learning model, a target phoneme feature representation or a combination of the target phoneme feature representation and a target duration feature representation based on the prompt speech feature representation and the target text feature representation.

8. The method of claim 1, wherein the text feature representation comprises byte-pair encoding (BPE) sequence of the sample text.

9. The method of claim 1, wherein the machine learning model is constructed based on a language model.

10. An electronic device, comprising:
at least one processor; and
at least one memory coupled to the at least one processor and storing instructions executable by the at least one processor, the instructions, upon execution by the at least one processor, causing the electronic device to perform operations comprising:
obtaining a training sample for training a machine learning model, the training sample comprising a sample speech, a sample text corresponding to the sample speech and speech duration information for the sample text, the machine learning model being configured to perform a plurality of tasks for speech processing;
extracting a speech feature representation from the sample speech, a text feature representation from the sample text, a phoneme feature representation and a duration feature representation for the phoneme feature representation from the speech duration information; and
training, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

11. The electronic device of claim 10, wherein a part of the speech feature representation is masked, and wherein training the machine learning model comprises:
generating, using the machine learning model, a combination of a predicted phoneme feature representation and a predicted duration feature representation based on an unmasked part of the speech feature representation, the text feature representation and a first part of the combination of the phoneme feature representation and the duration feature representation corresponding to the unmasked part of the speech feature representation; and
training, according to the first task, the machine learning model based on a difference between the combination of the predicted phoneme feature representation and the predicted duration feature representation and a second part of the combination of the phoneme feature representation and the duration feature representation corresponding to the masked part of the speech feature representation.

12. The electronic device of claim 10, wherein training the machine learning model comprises:
generating, using the machine learning model, a reconstructed text feature representation based on the speech feature representation; and
training, according to the second task, the machine learning model based on a difference between the reconstructed text feature representation and the text feature representation.

13. The electronic device of claim 10, herein training the machine learning model comprises:
generating, using the machine learning model, a reconstructed phoneme feature representation and a reconstructed duration feature representation based on the speech feature representation and the text feature representation; and
training, according to the third task, the machine learning model based on a difference between the reconstructed phoneme feature representation and the phoneme feature representation; or
training, according to the fourth task, the machine learning model based on a difference between a combination of the reconstructed phoneme feature representation and the reconstructed duration feature representation and the combination of the phoneme feature representation and the duration feature representation.

14. The electronic device of claim 10, the operations further comprising:
extracting a prompt speech feature representation from a prompt speech, a prompt text feature representation from a prompt text corresponding to the prompt speech, and a combination of a prompt phoneme feature representation and a prompt duration feature representation from prompt speech duration information for the prompt text; and
determining, using the trained machine learning model, a combination of target phoneme feature representation and target duration feature representation for a target speech based on the prompt speech feature representation, the prompt text feature representation, target text feature representation extracted from a target text corresponding to the target speech and the combination of prompt phoneme feature representation and prompt duration feature representation.

15. The electronic device of claim 10, the operations further comprising:
extracting a prompt speech feature representation from a prompt speech; and
determining, using the trained machine learning model, a target text feature representation based on the prompt speech feature representation.

16. The electronic device of claim 15, the operations further comprising:
determining, using the trained machine learning model, a target phoneme feature representation or a combination of the target phoneme feature representation and a target duration feature representation based on the prompt speech feature representation and the target text feature representation.

17. The electronic device of claim 10, wherein the text feature representation comprises byte-pair encoding (BPE) sequence of the sample text.

18. The electronic device of claim 10, wherein the machine learning model is constructed based on a language model.

19. A non-transitory computer readable storage medium having computer executable instructions stored thereon, the computer executable instructions, when executed by an electronic device, causing the electronic device perform operations comprising:
obtaining a training sample for training a machine learning model, the training sample comprising a sample speech, a sample text corresponding to the sample speech and speech duration information for the sample text, the machine learning model being configured to perform a plurality of tasks for speech processing;
extracting a speech feature representation from the sample speech, a text feature representation from the sample text, a phoneme feature representation and a duration feature representation for the phoneme feature representation from the speech duration information; and
training, according to the plurality of tasks, the machine learning model based on at least one of: the speech feature representation, the text feature representation or a combination of the phoneme feature representation and the duration feature representation, the plurality of tasks comprising a first task of duration prediction, a second task of automatic speech recognition (ASR), a third task of grapheme-to-phoneme (G2P) conversion and a fourth task of speech-text alignment.

20. The non-transitory computer readable storage medium of claim 19, wherein a part of the speech feature representation is masked, and wherein training the machine learning model comprises:
generating, using the machine learning model, a combination of a predicted phoneme feature representation and a predicted duration feature representation based on an unmasked part of the speech feature representation, the text feature representation and a first part of the combination of the phoneme feature representation and the duration feature representation corresponding to the unmasked part of the speech feature representation; and
training, according to the first task, the machine learning model based on a difference between the combination of the predicted phoneme feature representation and the predicted duration feature representation and a second part of the combination of the phoneme feature representation and the duration feature representation corresponding to the masked part of the speech feature representation.
